(19) United States
(12) Patent Application Publication
(10) Pub. No.: US 2025/0161938 A1
(43) Pub. Date: May 22, 2025

(54) PASSIVE OPTOFLUIDIC DEVICE

(71) Applicant: National Yang Ming Chiao Tung University, Taipei City (TW)

(72) Inventor: How-Foo CHEN, Taipei City (TW)

(21) Appl. No.: 18/420,413

(22) Filed: Jan. 23, 2024

(30) Foreign Application Priority Data
Nov. 22, 2023 (TW) 112145063

(51) Int. Cl. B01L 3/00

(52) U.S. Cl. CPC B01L 3/502715; B01L 2200/0684; B01L 2300/12; B01L 2300/161; B01L 2400/0406

(57) ABSTRACT

A passive optofluidic device capable of making a microfluidic fluid flow downward to a test zone via an entrance at one side of a three-dimensional microfluidic structure, and then rise upward to a bridge passage by means of a capillary action provided by an uplink microfluidic passage on the other side of the three-dimensional microfluidic structure, and then flow downward to a waste holding tank through the bridge passage, thereby enabling the microfluidic fluid to flow through the test zone to undergo an optical detection without the need of electrical energy and an infusion pump.

### BACKGROUND OF THE INVENTION

### Field of the Invention

The invention relates to optofluidic devices, especially to a passive optofluidic device.

### Description of the Related Art

General optofluidic devices are active optofluidic device, that is, they control the flow of a microfluidic fluid in an active manner, for example, by utilizing a small infusion pump, to assist an optical sensing device to perform a bio-optical detection on the microfluidic fluid.

However, as the active optofluidic device needs to be equipped with a small infusion pump to deliver a microfluidic fluid for detection, and the small infusion pump requires electrical energy and connection lines, it has the drawbacks of being bulky and not environmentally friendly.

In addition to the active optofluidic devices, there are also passive optofluidic devices on the market. For example, a passive optofluidic chip designed for transmissive detection. However, as the sample solution to be tested does not need to flow during the process of transmissive detection, the passive optofluidic chip only provides a planar detection area to contain the sample solution, and does not provide a flow mechanism for the sample solution. In other words, although the passive optofluidic chip does not require electrical energy, it can only contain the sample solution but cannot drive the sample solution to flow.

To solve the problems mentioned above, a novel optofluidic device is needed in the field.

### SUMMARY OF THE INVENTION

The main objective of the invention is to provide a passive optofluidic device, which can make a microfluidic fluid flow downward to a test zone via an entrance at one side of a three-dimensional microfluidic structure, and then rise upward to a bridge passage by means of a capillary action provided by an uplink microfluidic passage on the other side of the three-dimensional microfluidic structure, and then flow downward to a waste holding tank through the bridge passage, thereby enabling the microfluidic fluid to flow through the test zone to undergo an optical detection without the need of electrical energy and an infusion pump.

To achieve the above objective, a passive optofluidic device is proposed, which includes:
a microfluidic chip having a top layer, a connecting channel layer, and a test zone channel layer, where the top layer has a fluid injection hole; the connecting channel layer has a downward passage and a bridge passage, the upper end of the downward passage being connected with the fluid injection hole and the lower end of the downward passage being connected with the test zone channel layer; the test zone channel layer has a test zone passage and a waste holding tank, one side of the test zone passage being connected with the lower end of the downward passage and the other side being connected with one side of the bridge passage located above the test zone passage, and the other side of the bridge passage being connected with the waste holding tank below the bridge passage; and
a prism module having a prism and a gold film, the prism having a bottom surface, an incident surface, and an emergent surface, where the gold film is located above the bottom surface and forms a bottom wall of the test zone passage.

In one embodiment, the connecting channel layer is a single-layer structure.

In one embodiment, the connecting channel layer is a multi-layer structure.

In one embodiment, the microfluidic chip further includes a ventilation hole at the top layer, and the ventilation hole is connected with the waste holding tank to discharge a gas from the waste holding tank through the top layer of the microfluidic chip.

In one embodiment, the prism module has a glass layer or a light transmissive layer between the gold film and the prism, the light transmissive layer being homogeneous with the prism or having a substantially same refractive index as the prism.

In one embodiment, there is a first hydrophilic film between the top layer and the connecting channel layer.

In one embodiment, there is a second hydrophilic film between the connecting channel layer and the test zone channel layer.

In one embodiment, the microfluidic chip further has a bottom plate, and the bottom plate is beneath the test zone channel layer.

In one embodiment, the bottom plate is a hydrophilic layer.

To achieve the above objective, the invention further proposes a passive optofluidic device including:
a microfluidic chip having at least one test channel, each of which having a downward passage, a test zone, a hat-shaped passage, and a waste holding tank, where the downward passage has an upper end providing a fluid injection hole and a lower end connected with the test zone; one side of the test zone is connected with the downward passage and the other side of the test zone is connected with the hat-shaped passage; and one side of the hat-shaped passage is connected with the test zone and the other side of the hat-shaped passage is connected with the waste holding tank; and
a prism module having a prism and a gold film, the prism having a bottom surface, an incident surface, and an emergent surface, where the gold film is located above the bottom surface and forms a bottom wall of the test zone.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 illustrates a cross-sectional view of a passive optofluidic device according to one embodiment of the invention;

FIG. 2 illustrates a partial top view of a microfluidic chip of a passive optofluidic device according to another embodiment of the invention; and

FIG. 3 illustrates a partial bottom view of the microfluidic chip of FIG. 2.

### DETAILED DESCRIPTION OF THE PREFERRED EMBODIMENTS

The principle of the present invention resides in:
(A) Use a downward microfluidic passage of a three-dimensional microfluidic structure to lead a microfluidic fluid to flow downward to one side of a test zone.
(B) Use an uplink microfluidic passage on the other side of the test zone to provide a capillary force to make the microfluidic fluid move upward against gravity to a bridge passage.
(C) Use the bridge passage to lead the microfluidic fluid downward to a waste holding tank.

Accordingly, without the need of electrical energy and an infusion pump, the invention enables the microfluidic fluid to flow through the test zone to undergo an optical detection for the concentration of a specific molecular substance contained in the microfluidic fluid.

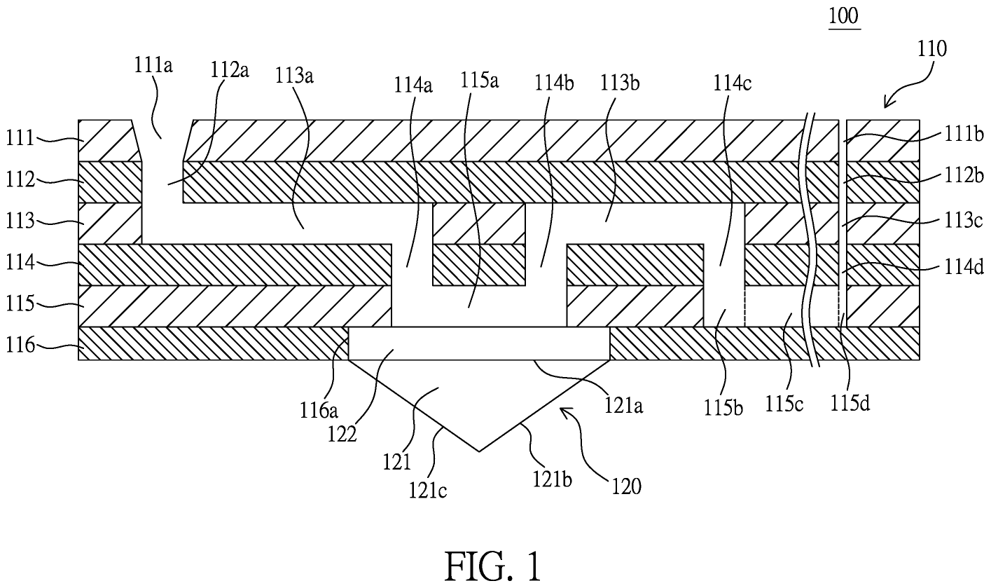

Please refer to FIG. 1, which illustrates a cross-sectional view of a passive optofluidic device according to one embodiment of the invention. As shown in FIG. 1, a passive optofluidic device 100 includes a microfluidic chip 110 and a prism module 120, where the microfluidic chip 110 has a top layer 111, a first hydrophilic film 112, a connecting channel layer 113, a second hydrophilic film 114, a test zone channel layer 115, and a bottom plate 116.

The top layer 111 has a fluid injection hole 111a and a ventilation hole 111b.

The first hydrophilic film 112 has a first introduction hole 112a and a first ventilation connecting hole 112b, where the first introduction hole 112a is connected with the fluid injection hole 111a and the first ventilation connecting hole 112b is connected with the ventilation hole 111b.

The connecting channel layer 113 has a downward passage 113a, a bridge passage 113b, and a second ventilation connecting hole 113c, where an upper end of the downward passage 113a is connected with the fluid injection hole 111a via the first introduction hole 112a, and a lower end of the downward passage 113a is connected with one side of a test zone passage 115a of the test zone channel layer 115 below the downward passage 113a; one side of the bridge passage 113b is connected with another side of the test zone passage 115a, and another side of the bridge passage 113b is connected with a waste holding tank 115c below the bridge passage 113b; and the second ventilation connecting hole 113c is connected with the first ventilation connecting hole 112b.

The second hydrophilic film 114 has a second introduction hole 114a, a capillary action aperture 114b, a downward leading aperture 114c, and a third ventilation connecting hole 114d, where the second introduction hole 114a connects the downward passage 113a with the test zone passage 115a, the capillary action aperture 114b connects the test zone passage 115a with the bridge passage 113b, and the downward leading aperture 114c connects the bridge passage 113b with the waste holding tank 115c; and the third ventilation connecting hole 114d is connected with the second ventilation connecting hole 113c.

The test zone channel layer 115 includes the test zone passage 115a, an introduction port 115b, the waste holding tank 115c, and a fourth ventilation connecting hole 115d, where one side of the test zone passage 115a is connected with the second introduction hole 114a, and another side of the test zone passage 115a is connected with the capillary action aperture 114b; the introduction port 115b connects the downward leading aperture 114c with the waste holding tank 115c; and the fourth ventilation connecting hole 115d connects the waste holding tank 115c with the third ventilation connecting hole 114d.

The bottom plate 116, which can be a hydrophilic membrane, has an opening 116a to accommodate the prism module 120.

The prism module 120 includes a prism 121 and a gold film 122, where the prism 121 has a bottom surface 121a, an incident surface 121b, and an emergent surface 121c, where the gold film 122 is located above the bottom surface 121a and forms a bottom wall of the test zone passage 115a.

In addition, the connecting channel layer 113 can be a single-layer structure or a multi-layer structure.

In addition, there can be a glass layer or a light transmissive layer between the gold film 122 and the prism 121, where the light transmissive layer is homogeneous with the prism 121 or has a substantially same refractive index as the prism 121.

In addition, the ventilation hole 111b, the first ventilation connecting hole 112b, the second ventilation connecting hole 113c, the third ventilation connecting hole 114d, and the fourth ventilation connecting hole 115d are connected with the waste holding tank 115c to discharge the gas from the waste holding tank 115c through the top layer 111 of the microfluidic chip 110.

When in operation, a sample solution is injected through the fluid injection hole 111a to flow through the first introduction hole 112a, the downward passage 113a, and the second introduction hole 114a to the test zone passage 115a; and then the capillary action aperture 114b provides a capillary force to cause the microfluidic fluid of the sample solution to move upward from the test zone passage 115a against gravity to the bridge passage 113b, and then flow through the bridge passage 113b, the downward leading aperture 114c and the introduction port 115b to the waste holding tank 115c. Thus, the sample solution can then undergo a reflected light intensity detection in the test zone passage 115a to determine the concentration of a particular molecular substance contained therein, where the reflected light intensity detection includes: using a light source 110 to illuminate the incident surface 121b of the prism 121, and utilizing a light sensor to detect the intensity of light emitted from the emergent surface 121c of the prism 121.

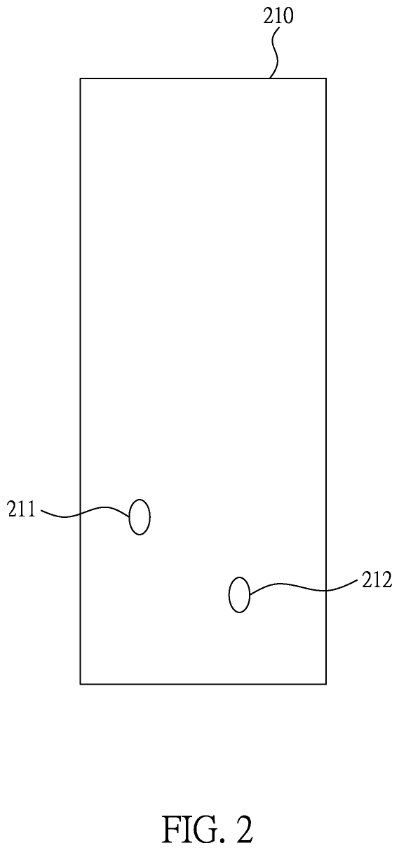

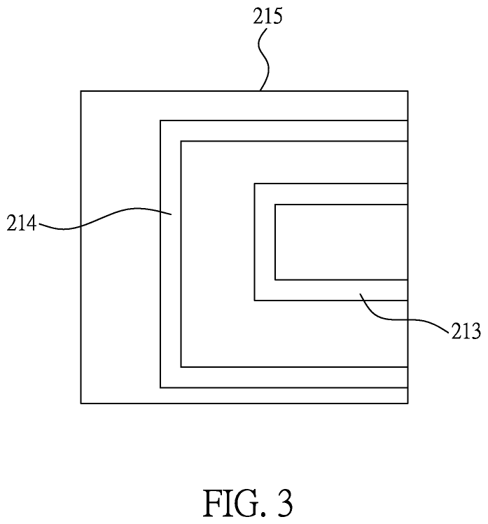

In addition, the microfluidic chip of the invention can have multiple test channels. Please refer to FIGS. 2 and 3 together, where the FIG. 2 illustrates a partial top view of a microfluidic chip of a passive optofluidic device according to another embodiment of the invention; and FIG. 3 illustrates a partial bottom view of the microfluidic chip of FIG. 2. As shown in FIG. 2, a microfluidic chip 210 has a first fluid injection hole 211 and a second fluid injection hole 212; and as shown in FIG. 3, the microfluidic chip 210 has a first test zone channel 213 and a second test zone channel 214, the first test zone channel 213 and the second test zone channel 214 are located in an area of a gold film 215 and the gold film 215 forms a bottom wall for both the first test zone channel 213 and the second test zone channel 214.

As can be seen from the description above, the invention proposes a passive optofluidic device, which includes: a microfluidic chip having at least one test channel, each of which having a downward passage, a test zone, a hat-shaped passage, and a waste holding tank, where the downward passage has an upper end providing a fluid injection hole and a lower end connected with the test zone; one side of the test zone is connected with the downward passage and the other side of the test zone is connected with the hat-shaped passage; and one side of the hat-shaped passage is connected with the test zone and the other side of the hat-shaped passage is connected with the waste holding tank; and a prism module having a prism and a gold film, the prism having a bottom surface, an incident surface, and an emergent surface, where the gold film is located above the bottom surface and forms a bottom wall of the test zone.

According to the designs mentioned above, the invention has the advantages as follows:

The passive optofluidic device of the invention can make a microfluidic fluid flow downward to a test zone via an entrance at one side of a three-dimensional microfluidic structure, and then rise upward to a bridge passage by means of a capillary action provided by an uplink microfluidic passage on the other side of the three-dimensional microfluidic structure, and then flow downward to a waste holding tank through the bridge passage, thereby enabling the microfluidic fluid to flow through the test zone to undergo an optical detection without the need of electrical energy and an infusion pump.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. A passive optofluidic device comprising:
a microfluidic chip having a top layer, a connecting channel layer, and a test zone channel layer, wherein the top layer has a fluid injection hole; the connecting channel layer has a downward passage and a bridge passage, the upper end of the downward passage being connected with the fluid injection hole and the lower end of the downward passage being connected with the test zone channel layer; the test zone channel layer has a test zone passage and a waste holding tank, one side of the test zone passage being connected with the lower end of the downward passage and the other side of the test zone passage being connected with one side of the bridge passage located above the test zone passage, and the other side of the bridge passage being connected with the waste holding tank below the bridge passage; and
a prism module having a prism and a gold film, the prism having a bottom surface, an incident surface, and an emergent surface, wherein the gold film is located above the bottom surface and forms a bottom wall of the test zone passage.

2. The passive optical fluidic device as disclosed in claim 1, wherein the connecting channel layer is a single-layer structure.

3. The passive optical fluidic device as disclosed in claim 1, wherein the connecting channel layer is a multi-layer structure.

4. The passive optical fluidic device as disclosed in claim 1, wherein the microfluidic chip further includes a ventilation hole, and the ventilation hole is connected with the waste holding tank to discharge a gas from the waste holding tank through the top layer of the microfluidic chip.

5. The passive optical fluidic device as disclosed in claim 1, wherein the prism module has a glass layer or a light transmissive layer between the gold film and the prism, the light transmissive layer being homogeneous with the prism or having a substantially same refractive index as the prism.

6. The passive optical fluidic device as disclosed in claim 1, wherein the microfluidic chip has a first hydrophilic film between the top layer and the connecting channel layer.

7. The passive optical fluidic device as disclosed in claim 6, wherein the microfluidic chip has a second hydrophilic film between the connecting channel layer and the test zone channel layer.

8. The passive optical fluidic device as disclosed in claim 7, wherein the microfluidic chip further includes a bottom plate beneath the test zone channel layer.

9. The passive optical fluidic device as disclosed in claim 8, wherein the bottom plate is a hydrophilic layer.

10. A passive optofluidic device comprising:
a microfluidic chip having at least one test channel, each of which having a downward passage, a test zone, a hat-shaped passage, and a waste holding tank, where the downward passage has an upper end providing a fluid injection hole and a lower end connected with the test zone; one side of the test zone is connected with the downward passage and another side of the test zone is connected with the hat-shaped passage; and one side of the hat-shaped passage is connected with the test zone and another side of the hat-shaped passage is connected with the waste holding tank; and
a prism module having a prism and a gold film, the prism having a bottom surface, an incident surface, and an emergent surface, wherein the gold film is located above the bottom surface and forms a bottom wall of the test zone.
